(19) United States
(12) Patent Application Publication
(10) Pub. No.: US 2020/0143442 A1
(43) Pub. Date: May 7, 2020

(54) RESELLER EXCHANGE SYSTEM

(71) Applicant: HEMANT PASSI, South Turramurra (AU)

(72) Inventor: HEMANT PASSI, South Turramurra (AU)

(21) Appl. No.: 16/659,560

(22) PCT Filed: Apr. 20, 2018
(86) PCT No.: PCT/AU2018/050368

§ 371 Date: Oct. 21, 2019

(30) Foreign Application Priority Data
Apr. 21, 2017 (AU) 2017901456

(51) Int. Cl. G06Q 30/06; G06Q 30/02

(52) U.S. Cl. CPC G06Q 30/0613; G06Q 30/0283; G06Q 30/0603

(57) ABSTRACT

A reseller exchange system (RES) that allows a telecommunications provider to market/sell products/services of a third-party provider to its customers is disclosed. The (RES) stores a product/service catalogue of one or more products/services of one or more third party providers and a database including one or more agreements between a telecommunications provider and at least one of one or more customers or one or more third party providers. Further, the RES communicates with disparately located one or more clients. The RES customizes billing details of the one or more products/services to be marketed and/or sold to the one or more customers using the one or more agreements. The RES is configured to override pricing of any product from any third party provider or to any customer on any transaction, as may be required in negotiations with the customer and/or third party provider.

### FIELD OF INVENTION

The present disclosure relates to data processing systems, specifically the present disclosure relates to a reseller exchange system.

### BACKGROUND

A telecommunications provider provides one or more standard products/services to enterprises (like a business, an organisation, a corporate, a non-profit entity, a non-individual customer, small to medium business, etc. herein after referred to as a “customer”). The standard products include devices including without limitation mobile devices, mobile phones/cell phones, corded handsets, hotspot devices, tablets and portable or fixed devices which make use of data (whether wired or wireless) and/or calling capability. The services include without limitation ability to make domestic and/or international calls via fixed (corded) or mobile devices, ability to make calls to and from international locations using the mobile devices and access to data via fixed or mobile devices, both domestic and international (roaming).

Further, a telecommunications provider may seek to expand its business by offering additional products/services to the customers to maintain competitive edge in the business world. The additional products/services include without limitation any type of device not referred to herein as a standard product, as well as products/services such as cloud-based storage, data encryption, provision for backup and recovery, device security and management services, etc. These additional products/services may include products/services of third parties such as device manufacturers, suppliers, vendors, traders, retailers, etc. Thus, the telecommunications provider becomes a reseller of the additional products/services of the third party as it engages the additional products/services of a third party.

A telecommunications provider may be preferred over a third-party provider by a customer due to a number of reasons such as supply chain optimisation, supplier rationalisation, volume pricing benefits available through the telecommunications provider as a volume reseller, general impression of the telecommunications provider on the customer or any number of other reasons. Alternately, the third party provider may wish to offer the products and/or the services through the telecommunications provider as a reseller in order to access a significant market of the telecommunications provider.

In either of the aforementioned scenarios, though possibly beneficial for the business, a telecommunications provider is required to perform numerous tasks like logistics related to the products/services, invoicing a customer, reimbursement to the third party provider, etc. This may become further complex with diverse products/services having different pricing and/or service level guarantees/agreements for a customer. The telecommunication provider may thus be required to incur high management cost and logistical overhead.

### BRIEF DESCRIPTION OF DRAWINGS

FIG. 1 illustrates a first exemplary diagram of a reseller exchange system consistent with the principles of the present invention;

FIG. 1a illustrates a second exemplary diagram of the reseller exchange system consistent with the principles of the present invention;

FIG. 1b illustrates a third exemplary diagram of the reseller exchange system consistent with the principles of the present invention;

FIG. 1c illustrates a fourth exemplary diagram of the reseller exchange system consistent with the principles of the present invention;

FIG. 2 illustrates an exemplary diagram of a server or client according to an implementation consistent with the principles of the present invention;

FIG. 3 illustrates the modular diagram of a reseller exchange system in accordance with an embodiment of the present invention;

FIG. 4 illustrates an exemplary table of an agreement between a third party provider and a telecommunications provider according to an implementation consistent with the principles of the present invention;

FIG. 5 illustrates a flowchart 500 depicting a registration process followed by a third party provider or a customer on the reseller exchange system;

FIG. 6 illustrates a flowchart 600 depicting functioning of the reseller exchange system consistent with the teachings of the present invention.

### DESCRIPTION

Methods and systems for a reseller exchange system are disclosed. The following description is presented to enable any person skilled in the art to make and use the invention. For purposes of explanation, specific nomenclature is set forth to provide a thorough understanding of the present invention. Descriptions of specific applications are provided only as examples. Various modifications to the preferred embodiments will be readily apparent to those skilled in the art, and the general principles defined herein may be applied to other embodiments and applications without departing from the spirit and scope of the invention. Thus, the present invention is not intended to be limited to the embodiments shown but is to be accorded the widest scope consistent with the principles and features disclosed herein.

The embodiments as described below can be implemented as methods, apparatus, systems, and computer program products. It should be understood that each module described below may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the data flow illustrations or modules.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified below.

Further applications, software programs or computer executable instructions may be referred to as components or modules. Applications may be hardwired or hardcoded in hardware or take the form of software executing on a general purpose computer such that when the software is loaded into and/or executed by the computer, the computer becomes an apparatus for practicing the invention, or they are available via a web service. Applications may also be downloaded in whole or in part through the use of a software development kit or a toolkit that enables the creation and implementation of the present invention. In this specification, these implementations, or any other form that the invention may take, may be referred to as techniques. In general, the order of the steps of disclosed processes may be altered within the scope of the invention.

In the exemplary embodiments elaborated below, the present invention provides a reseller exchange system to meet a customers' need as well as allows a telecommunications provider to expand its business without changing a core operational system.

The reseller exchange system allows the telecommunications provider to act as a reseller to market and/or sell the products/services of one or more third parties to its current/prospective customers. Further, the reseller exchange system allows the telecommunications provider to offer a wide range of the products/services to the customers, without incurring a significant management overhead.

Yet another advantage of the reseller exchange system is that it allows a telecommunications provider to integrate one or more third party providers at one place and store all relevant information regarding the products/services that the telecommunications provider can offer to its customers including standard pricing. In an embodiment, the reseller exchange system enables the telecommunications provider to dictate and/or override pricing of any product/service of a third-party provider while offering to sale to its customers. In an embodiment, the reseller exchange system allows the telecommunications provider to assemble a ‘bundle’ of multiple products/services from one or more third party providers, and present this bundle of disparate products/services as a single product/service to one or more customers.

The reseller exchange system of the present invention works directly with a telecommunications provider's software ecosystem to acquire and ingest all relevant information relating to the product and/or services of one or more third-party providers. The product information includes without limitation product name, name of an operating system, hard drive specification, display specification, pricing details and/or other technical specification while the services information includes without limitation subscription details, guarantee period/warranty period, volume pricing benefits, duration of license/subscription, multi-device/single device, single user/volume license etc.

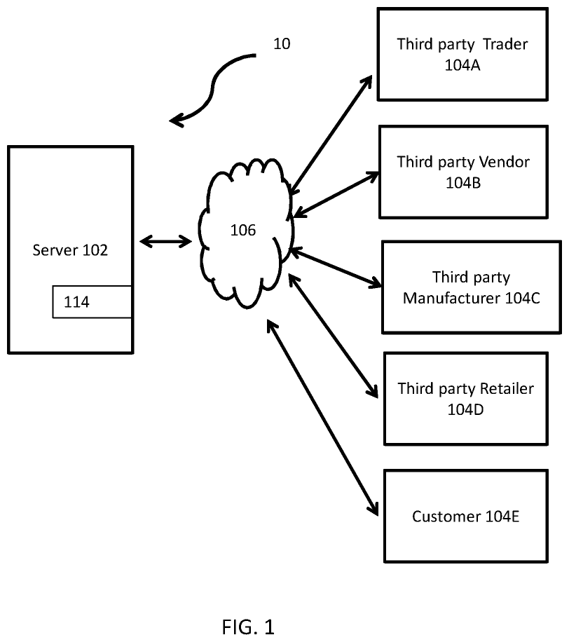

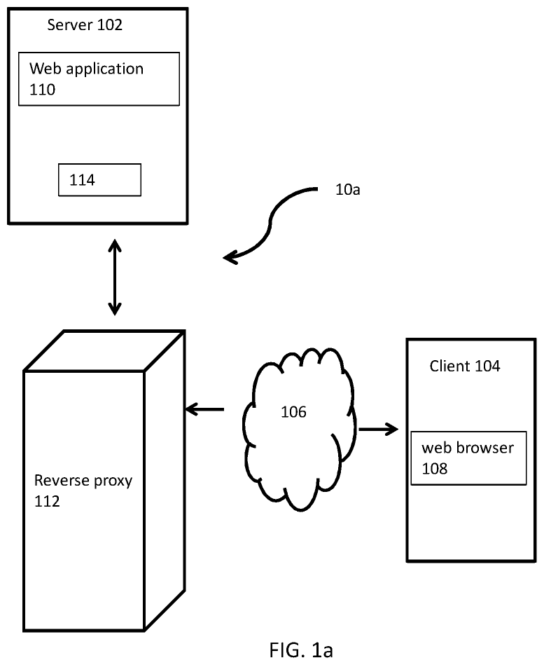

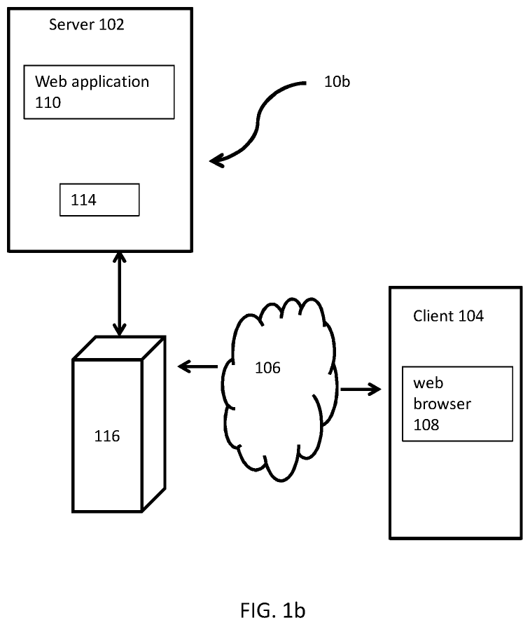

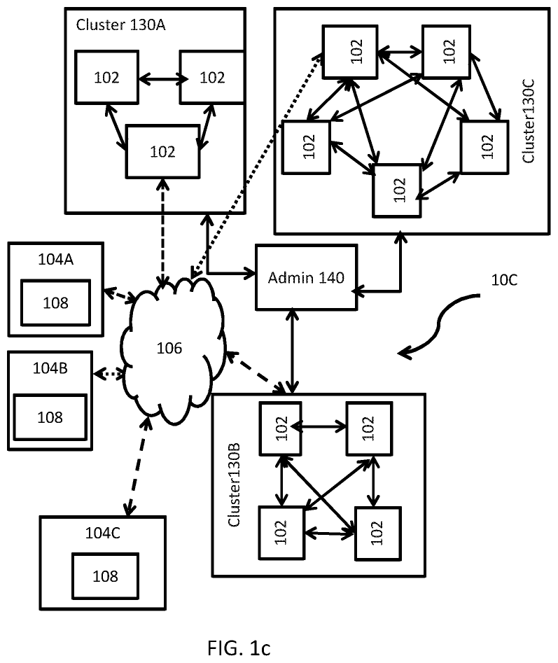

Referring to FIG. 1 illustrates a first exemplary diagram of the environment 10 of a reseller exchange system 114 consistent with the principles of the invention. The environment 10 includes a server 102, one or more clients 104A, 104B, 104C, 104D, 104E and network 106. In this embodiment, the reseller exchange system 114 is resident on the server 102 of a telecommunications provider (‘not shown’) and one or more clients 104A, 104B, 104C, 104D (“customers/third party providers”) communicate with the server 102 via the network 106.

The “server” 102 is typically a remote computer system on which the reseller exchange system 114 is installed and is accessible over the network 106 such as the Internet. The server essentially acts as an information provider to one or more clients. In various embodiments of the present invention, the server 102 may be a cloud-server, a content server, an application server, a web server, a virtual server or an equivalent device that is capable of accessing a network environment based upon a request received from the client and accordingly fetches the content. The server 102 hosts the reseller exchange system 114 which acquires and ingests all relevant information relating to the product and/or services of one or more third-party providers. Further, the reseller exchange system 114 enables the telecommunications provider to dictate and/or override pricing of any product/service of a third-party provider while offering for sale to its customers. In an embodiment, the reseller exchange system allows the telecommunications provider to assemble a ‘bundle’ of multiple products/services from one or more third party providers, and present this bundle of disparate products/services as a single product/service to one or more customers.

Further, the reseller exchange system 114 facilitates enrolment of one or more customers, one or more third party providers, one or more products/services, etc. Additionally, the reseller exchange system 114 is configured to acquire agreement details between the one or more customers and the telecommunications provider and one or more third party providers and the telecommunications provider. In an embodiment, the reseller exchange system 114 displays one or more products/services offers with details such as special pricing, warranty period, configuration/technical specification of a device (‘product’)/features of a license, etc. via the network 106 from the server 102 (or other repository). Alternatively, the one or more customers via of the client device 104 submit a request for purchasing the one or more product(s)/service(s). Additionally, one or more customers receive an invoice reflecting an amount corresponding to the purchase made through the reseller exchange system 114 as per the teachings of the present disclosure.

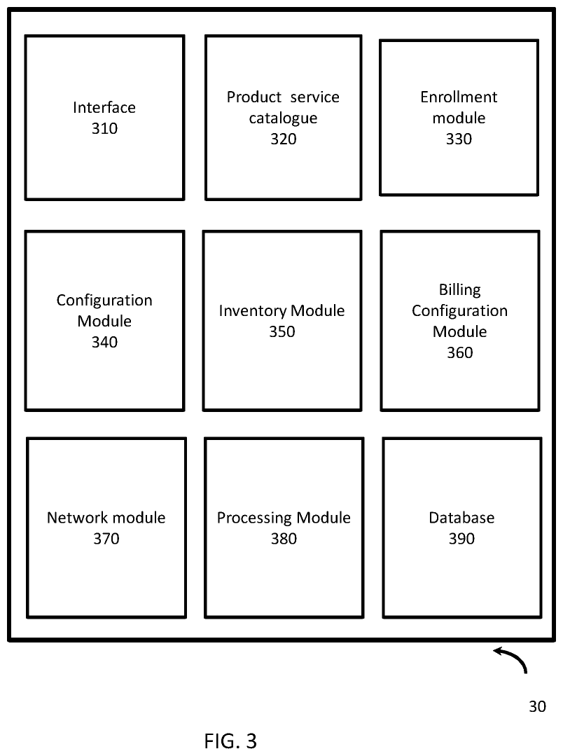

The reseller exchange system 114 includes various modules such as a product/service catalogue, an enrolment module, a configuration module, an inventory module and a billing configuration module as described in detail in FIG. 3.

In an embodiment of the present invention, the server 102 may operate as a web server and host one or more web applications. The web application may be any computer-based software application or webpage that may be hosted by the server 102 and accessed by the client 104 via computer network 106, such as the Internet.

Client 104 may be a computing device such as a wireless telephone, a personal computer, a personal digital assistant (PDA), a laptop, a tablet or another type of computation and/or communication device, a thread or process running on one of these devices, and/or an object executable by one of these devices. Client 104 may include a client software such as the web browser 108 like Firefox, Chrome, Internet Explorer, Safari, Opera etc. to correspond with the server 102. Alternately, a computer program such as a web application, a mobile application, a software application, a widget, or the like resides on the client that is used to correspond with the server. In a typical scenario, a user (third party provider/customer) of the client 104 using a web browser 108 may send a request for a web application (by URL, link within an email, link within a web page, or otherwise) to the server 102. In an embodiment, the communication may be established using an Internet Protocol for example, a hypertext transfer protocol (HTTP)/hypertext transfer protocol secure (HTTPS), file transfer protocol (FTP), etc.

The one or more client devices 104A, 104B, 104C, 104D without limitation include one or more customers such as a business, an organisation, a corporate, a non-profit entity, a non-individual customer, a small to medium business, an individual, etc. while the one or more third party providers may be such as device manufacturers, suppliers, vendors, traders, retailers, service providers, etc. As depicted in FIG. 1, the one or more third party providers include one or more third party traders 104A, one or more third party vendors 104B, one or more third party manufactures 104C and one or more third party retailers 104D. Also, one or more customers 104E who are the buyers of the one or more product/services available through the reseller exchange system 114 is depicted in FIG. 1a Thus, the reseller exchange system 114 aids the telecommunications provider to expand their business by reselling of additional products/services of the one or more third party providers (‘clients’).

The one or more client devices 104A, 104B, 104C, 104D and the server 102 have been illustrated as communicating via the network 106 for simplicity. In practice, there may be more clients and servers. Also, in some instances, a client may perform the functions of a server and a server may perform the functions of a client.

The network 106 establishes communication between the server 102 and the one or more client 104A, 104B, 104C, 104D. The network 106 used may be a global area network (GAN), such as the Internet, a wide area network (WAN), a local area network (LAN), or any other type of network or combination of networks. The network 106 may provide for wireline, wireless, or a combination of wireline and wireless communication between devices in the network. In some embodiments of the invention, the network 106 described herein may be a cloud computing network or the network may be a WiFi network, Bluetooth, or networks provided by cell towers such as 2G, 2.5G, 3G, 4G, 5G, etc.

Referring now to FIG. 1(a), which illustrates a second exemplary environment in which the teachings of the present disclosure may be practiced. The environment 10 includes a web browser 108 running on one or more clients 104A, 104B, 104c, 104D that establishes communication with a reseller exchange system 114 via a web application 110 located on a web server 102 via a reverse proxy server 112, through the network 106. For ease of understanding, single hardware elements like client, web server, reverse proxy, etc. are depicted in FIG. 1(a), however, it would be apparent to a person skilled in the art that several such elements may be employed as per the teachings of the present disclosure.

Web server 102 may include a computational device for example, a dedicated computer that responds to the requests of one or more clients 104 and has data processing capability.

Client 104 and reverse proxy server 112 may connect to network 106 via wired, wireless, optical or any other type of connection that allows communication.

The reseller exchange system 114 may include an interface module, a product service catalogue, an enrollment module, a configuration module, an inventory module a billing configuration module, a network module, a processing module and a database to acquire and ingest all relevant information relating to the product and/or services of one or more third-parties and for maintaining the inventory of relating to the product and/or services of one or more third-parties in a manner consistent with the principles of the invention. These will be further explained in FIG. 3.

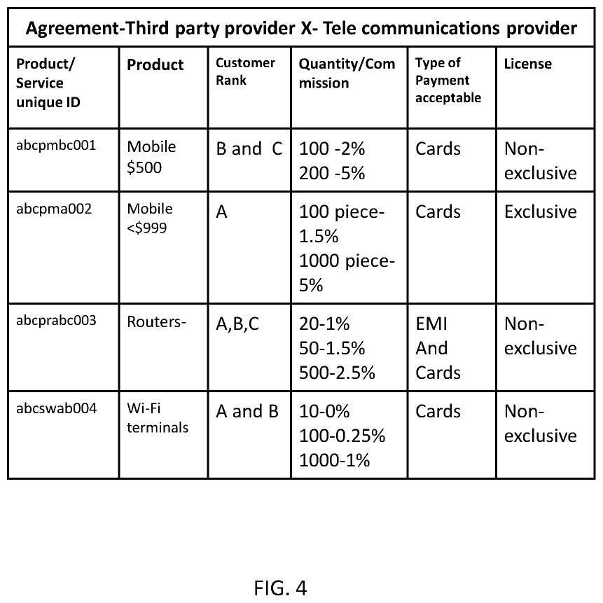

Further, the reseller exchange system 114 is configured to provide an increasingly diverse and/or complex array of products and services to the customers of the telecommunication providers, often with different pricing and/or service level guarantees to different customers. Moreover, the reseller exchange system 114 manages one or more agreements. The reseller exchange system 114 without limitation includes one or more first category and one or more second category of agreements. The one or more first category of agreements is an agreement between one or more third party providers and the telecommunications providers (herein after referred as AGG_TPP). The AGG_TPP allows the telecommunication provider (‘reseller’) to generate commission through the third party provider based on the purchase made through the reseller exchange system 114. The AGG_TPP without limitation includes type of products/services to be offered to a specific/selective category of customers, quantity vs. commission, a type of license with the reseller, duration of agreement etc. as depicted in FIG. 4. The one or more second category of agreements is the agreement between one or more customers and the telecommunications provider (AGG_C). The AGG_C allows the reseller to negotiate with the customers on aspects such as offering discount based on number of pieces/licenses of products/services per transaction subject to volume pricing, exclusive/non-exclusive license, territory, discount depending on customer's rank, type of payments (lump sum/instalments), mode of payments (cash/card), etc.

The reverse proxy server 112 and the web server 102 may connect via wired, wireless, optical or any other type of connection that allows communication. A reverse proxy server 112 is a server with data processing and communication capabilities on which the teachings of the present disclosure are implemented.

In an embodiment, the web server 102 may receive a client 104 request via the reverse proxy server 112 and send its response to the client 104 via the reverse proxy server 112. Alternately, the server 102 may receive a client 104 request directly and send its response to the client 104 via the reverse proxy server 112.

Alternatively, the reseller exchange system 114 may be placed at a geographic location different from that of the web server 102 in which case, rather than the reverse-proxy server, a collaborating proxy server exists as depicted in the environment 10b of FIG. 1(b).

As shown in the FIG. 1(b), it illustrates a third exemplary environment in which the teachings of the present disclosure may be practiced. The web browser 108 running on the client 104 may establish communication with the reseller exchange system 114 hosted on the server 102 via a collaborating proxy server 116 through the network 106. The collaborating proxy server 116 may communicate with the reseller exchange system (RES) 114 on which the teachings of the present disclosure may be implemented. Examples of the collaboration proxy server 116 include without limitation, the reseller exchange system (RES) 114 being co-located or in-front of a web infrastructure element, such as web application firewalls (WAF), load balancers, or application proxies of any kind.

The reseller exchange system 114 may not access network environment based upon a request received from one or more clients 104A, 104B, 104C, 104D or may not fetch the content from the server 102 directly, rather may rely on the collaborating proxy server 116 for fetching/updating the content. The collaborating proxy server 116 may capture the network environment and forward the request/data/content from the one or more clients to the reseller exchange system 114. In each response sent to the web browser 108, the reseller exchange system 114 may provide content such as, one or more products/services with details such as special pricing, warranty period, configuration of a device/features of a license, etc. to be displayed at the client 104.

As shown in the FIG. 1(c), a fourth exemplary environment 10C in which the teachings of the present disclosure may be practiced is illustrated. The environment 10c of the RES 114 architecture may include one or more server clusters 130A, 130B, 130C, an administration tool 140 and one or more clients 104A, 104B, 104C in communication with the one or more server clusters 130A, 130B, 130C as per the teaching of the present invention. Although only three server clusters 130 are shown in FIG. 1c, no limitation of the principles of the invention is intended. Such system environment 10c may include any number of server clusters 130 and have any number of clients 104 in communication with those clusters 130.

Each server cluster 130A, 130B, 130C is a logical group of one or more servers 102 (hereafter referred to generally as server 102 or servers 102) that are administered as a single entity. The servers 102 within each cluster can be heterogeneous. That is, one or more of the servers can operate according to one type of operating system platform (e.g., WINDOWS NT, manufactured by Microsoft Corp. of Redmond, Wash.), while one or more of the other servers 102 can operate on according to another type of operating system platform (e.g., Unix or Linux). Each server cluster does not need to be physically proximate to other servers in its cluster. Thus, the group of servers 102 logically grouped as a server cluster 130A, 130B, 130C may be interconnected using the network 106. By way of example, a server cluster may include servers 102 physically located in different regions of a state, city, campus, or room. Example of server cluster 130A, 130B, 130C includes distributed system architecture for handling volume requests to one or more servers 102.

An administration tool 140 may be used to modify or create rules, group rules into load evaluators, or display the results of a load evaluation for a particular server 102.

Similarly, an administrator can use the administration tool 140 to query the load information for each server 102 and display this load information in accordance with a particular requested view. For example, the administration tool 140 may display overall server load, the value of a particular operational meter or a rule at a particular time, or some combination of these views. In one embodiment, the administrator may “test” the Load Management System (LMS) by requesting the LMS to perform a server load calculation and display the server to which a client 104 would have been connected had a client made a request. The load information displayed by a monitoring system may include current as well as historical data (e.g., processor and memory utilization, page fault occurrences) for a particular server 102 or application.

For example, the client 104A may communicate with a server of the server cluster 130B through the network 106. The client 104A may, for example, request for information/content through the web browser 108 from the reseller exchange system (RES) 114. The client 104A request is received by the administration tool 140. The administration tool 140 post interpreting the client 104A request identifies the server cluster 130B and thereafter selects the server 102 from a group of servers 102 in the said server cluster 130B for routing the client 104A request as depicted in FIG. 1C. In an embodiment while interpreting the client 104A request, the administration tool 140 without limitation analyses location of the client, nearest server cluster so that faster response may be received, number of client requests handled by each server 102 in the identified server cluster for load management, type of information requested such as (product/service/volume), delivery location etc. Once the administration tool 140 identifies the server 102, the administration tool 140 forwards the request of the client 104A to the server 102. The server 102 in conjunction with the reseller exchange system 114 responds to the request through the web browser 108 as per the teachings of the present invention.

It should be noted that the above four embodiments are exemplary. For example, rather than a reverse proxy server/collaborating proxy server employed for intercepting the communication, a remote proxy server which may be a cloud based version of the service may be used. In such scenario, the remote proxy server performs all the functions of the reverse proxy server/collaborating proxy server. Yet another exemplary implementation may be to rely on a remote proxy server, such as content delivery network (CDN), which sends the intercepted web application code to a cloud based version of the service. Similar other implementations of the RES 114 employed in conjunction with the present invention are within the scope of the present disclosure.

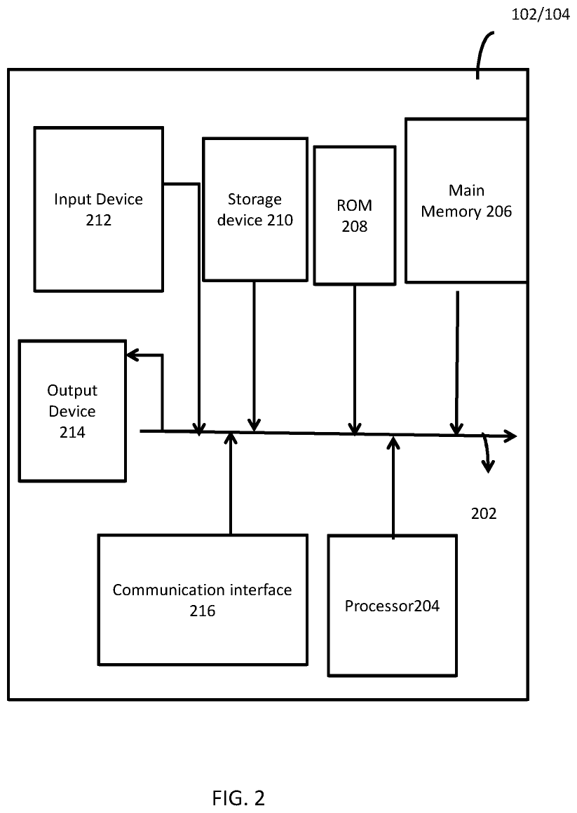

FIG. 2 is an exemplary hardware component diagram of the server 102 or client 104 according to an implementation consistent with the principles of the invention. The server/client 102/104 may include a bus 202, a processor 204, a main memory 206, a read only memory (ROM) 208, a storage device 210, one or more input devices 212, one or more output devices 214 and a communication interface 216.

The bus 202 may include one or more conductors that permit communication among the components of client/server 102/112.

The processor 204 may include any type of conventional processor or microprocessor, or a combination of processors, that interprets and executes instructions.

The main memory 206 may include a random access memory (RAM) or another type of dynamic storage device that stores information and instructions for execution by processor 204.

The ROM 208 may include a conventional ROM device or another type of static storage device that stores static information and/or instructions for use by processor 204.

The storage device 210 may include a magnetic and/or optical recording medium and its corresponding drive.

The input device(s) 212 may include one or more conventional mechanisms that permit a user to input information to server/client 102/104, such as a keyboard, a mouse, a pen, a touch screen, voice recognition and/or biometric mechanisms, etc.

The output device(s) 214 may include one or more conventional mechanisms that output information to the user, including a display, a printer, a speaker, etc.

The communication interface 216 may include any transceiver-like mechanism that enables server/client 102/104 to communicate with other devices and/or systems. For example, the communication interface 216 may include mechanisms for communicating with another device or system via a network, such as network 106.

The software instructions or computer-executable instructions defining reseller exchange system 114 and/or browser software 108 may be read into memory 206 from another computer-readable medium, such as data storage device 210, or from another device via the communication interface 216. The software instructions or computer-executable instructions contained in the memory 206 causes processor 204 to perform processes that will be described later. Alternatively, hardwired circuitry may be used in place of or in combination with software instructions to implement processes consistent with the principles of the disclosure. Thus, implementations consistent with the principles of the disclosure are not limited to any specific combination of hardware circuitry and software.

FIG. 3 illustrates modular diagram of the reseller exchange system in accordance with an embodiment of the present invention. The reseller exchange system 114 includes various modules without limitation, an interface module 310, a product service catalogue 320, an enrollment module 330, a configuration module 340, an inventory module 350, a billing configuration module 360, a network module 370, a processing module 380, and a database 390. In other embodiments, the reseller exchange system 114 may comprise a subset of one or more of the depicted modules 310, 320, 330, 340, 350, 360, 370, 380 and 390 or the like.

Interface module 310 allows users to interact with the clients 104A, 104B, 104C, 104D through graphical icons and/or visual indicators. In an embodiment, when the client is a third party provider, the interface module 310 allows the third party provider to register with the reseller exchange system 114. Without registration, the third party provider may not be allowed to do business through the reseller exchange system 114. The interface module 210 without limitation may include fields such as business entity legal name, business type (say, sole trader, partnership, company or trust), industry type (product/service or product and service), registered address, business phone, business email, taxpayer Identification number, contact information of the business entity-representative of the business entity. In an embodiment, the interface module 310 activates reseller account once the details provided during registration are verified. The verification process may be manual or may comprises of a plurality of screens enquiring for information that is used for cross-checking at back end by the telecommunications provider in order to complete the verification process.

Additionally and optionally, the interface module 310 may include AGG_TPP agreement fields without limitation term of agreement (initial term/automatic renewal/not to renew), frequent need to aggregate usage of one or more products/services, billing pattern/prices for products/services per transaction subject to volume pricing, changing market prices, volume commissions, exclusive/non-exclusive license, territory, discount depending on customer's rank, interest on late payments and enforcements etc. The agreement details may be provided during the registration process by the third party provider or may be provided after the third party provider's account is verified. Optionally, once the agreement (AGG_TPP) is mutually agreed between the third party provider and the telecommunication provider, the third party provider may be allowed to enroll one or more products/services into the reseller exchange system 114.

In another embodiment of the present invention, the interface module 310 includes product/service enrolment fields without limitation product/service name, item dimension and weight, material, price, payment mode (cards/Equated Monthly Instalment (EMI)/cash etc.), brand, colour, connectivity technology, data transfer rate, technical standards compatibility, network type, installation cost, shipping cost (if any), seller's rank, product description, warranty/guaranty, configuration/technical specification, pricing, subscription period (in case of service) etc. In an embodiment of the present invention, the pricing of the one or more products/services is used for calculating special pricing. In an exemplary embodiment, the special pricing may be generated based on a commission value agreed between the one or more third party providers and the telecommunication provider and/or based on discount value agreed between the one or more customers and the telecommunications provider.

Alternately, the interface module 310 may include provisions for hooking server details of the third party provider with the reseller exchange system 114.

In yet another embodiment of the present invention, the interface module 310 includes customer registration fields without limitation such as a business entity legal name, business type (say, sole trader, partnership, company or trust), a registered address, one or more business phones, business emails, etc., taxpayer Identification number (optional), contact information of the business entity-representative of the business entity, individual details, etc. Additionally and optionally, the interface module 310 may include AGG_C agreement fields without limitation term of agreement (initial term/automatic renewal/not to renew), discount for products/services per transaction subject to volume pricing, exclusive/non-exclusive license, territory, type of payment (lump sum/instalment), etc.

Optionally, the interface module 310 allows the customers to provide feedback related to the products/services and may allow the one or more customers to ask specific queries regarding the product/service.

The product/service catalogue 320 stores details of one or more products/services offered by one or more third-party providers. Details of the one or more products/services can be referred from the above description. In an embodiment of the present invention, product/service catalogue 320 includes product/service categories such as telephones, mobile phones, walkie-talkie, fax machines, modems, answering machines, antenna, cables, set top box, transmission systems, climate control, security monitoring and credit card terminals etc. Further details include without limitation product and/or service to be displayed to a customer, pricing of a product and/or service to be displayed to a customer, special discount for a product and/or service to be displayed to a customer, etc. The product/service catalogue 320 may have unique ids for each product and each service that are stored in the one or more lookup tables along with the details of the product/service.

The enrolment module 330 stores one or more agreements between one or more customers and telecommunications provider. For example, the enrolment module 330 may contain one or more look-up tables to map agreement details between the one or more customers and the telecommunications provider. Such agreement details include without limitation customer relationship grade, term of agreement, product/service interest, yearly/monthly financial earnings through the customer, etc. In an embodiment, the enrolment module 330 includes deals on particular product and/or services or a class of product and/or services specific to a select few customers based on the agreement.

Additionally, the enrolment module 330 stores one or more AGG_TPP agreements between one or more third-party providers and the telecommunications provider. For example, the enrolment module 330 may contain one or more look-up tables to map agreement details between the one or more third-party providers and the telecommunications provider as depicted in FIG. 4. The agreement (AGG_TPP) details include without limitation one or more variables which can be configured as part of a contract/agreement, a term of an agreement (Initial Term/automatic renewal/not to renew), frequent need to aggregate usage of one or more products/services, billing pattern/prices for products/services per transaction subject to volume pricing, changing market prices, volume commissions, exclusive/non-exclusive license, territory, discount depending on customer's rank, interest on late payments and enforcements, etc.

The configuration module 340 enables the user (third party provider/customer) to configure settings of the reseller exchange system 114 at an instance when the reseller exchange system 114 is executed for first instance on any client device. Alternatively or optionally, the configuration module 340 facilitates reconfiguration of the settings at any time during the use of the reseller exchange system 114. The configuration settings may include receiving notification (daily/weekly/fortnightly) for the one or more products/services purchase, notification for customer feedback, alert for each product/service when number of units/licenses are below a limit in the inventory of the reseller exchange system 114 so that the third party provider may provide new stock, etc.

Further, the configuration module 340 is configured to override standard pricing on any individual transaction. This includes the price offered to the customer and the procurement price paid to the third party provider. For example, the configuration module 340 may be configured to check the history of purchases made by the customer and accordingly provide an additional discount, thus overriding the standard pricing and presenting an alternate pricing.

Additionally and optionally, the configuration module 340 is configured to manage details of the products/services including details that are visible to the one or more customer(s) (pricing, product type, product make, weight, etc.) and details that are for internal reference (maximum discount that can be offered, condition when a discount is applicable, etc.).

The inventory module 350 maintains an inventory of the product and/or service of the third party providers. Alternatively, the inventory module 350 may exchange inventory details of the product and/or services with an account payable system of the telecommunications provider either in real-time or once a request for purchase of a product/service is received. The inventory details include without limitation number of pieces (‘units’)/licenses of a product/service, etc.

The billing configuration module 360 is configured to maintain records of both accounts payable pricing to the third party provider and accounts receivable pricing from the customer. The billing configuration module is configured to communicate with the accounts payable system of the telecommunications provider to accurately invoice the customers. Accordingly, the billing configuration module 360 corresponds with the account payable system to inject an amount corresponding to the product and/or service(s) purchased by a customer via the telecommunications provider. Alternately, the billing configuration module 360 corresponds with an account payable system to charge a customer an amount agreed in the negotiated contract/agreement between the telecommunications provider and the third party provider, taking into account one or more variables which can be configured as part of the contract such details without limitation include per transaction subject to volume pricing, changing market prices, volume commissions and other reasons. Also, the billing configuration module 360 is configured to communicate with the accounts payable system of the telecommunications provider to accurately pay commission to the third party providers corresponding to the purchase made by the one or more customers.

Additionally and optionally, the billing configuration module 360 is configured to add a charge for any product or service purchased by the telecommunications provider's customer(s) to a customer's regular bill. Alternatively, depending on the configuration setting in the reseller exchange system 114, the billing configuration module 360 may generate a separate invoice corresponding to the products and/or services purchased by the customer at an instant.

The network module 370 obtains the network environment information in a request received from the one or more clients 104A, 104B, 104C, 104D. The request may be a request for content with or without network environment information and may be received periodically or only when the content is requested. The network environment information includes without limitation network type, network speed, bandwidth, etc.

The processing module 380 coordinates the functioning of all modules.

The database 390 is used to store profiles of one or more customers, one or more third party providers and the product/service catalogue 320. Additionally, the database 390 also include one or more look up tables to stores one or more agreements of the enrolment module 330, special pricing configuration module 340, one or more look up tables having stock details of the one or more products/services of inventory module 350 details and the billing module 350 information.

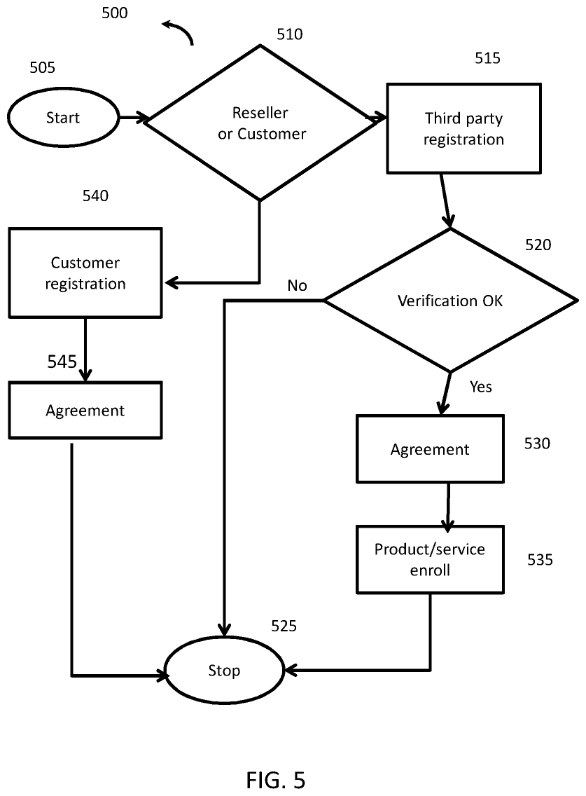

Referring to the FIG. 5 illustrates a flowchart 500 depicting the process followed for client registration on the reseller exchange system 114.

The process commences at step 505. The user of the client 104 is provided with an option to either register as a third party provider or a customer at step 510. In case the user selects the option for registering as a third party provider then, the third party provider registration form is displayed at step 515. In an embodiment, the user fills the registration fields as per details mentioned in FIG. 3.

Once a third party provider registers with the reseller exchange system 114, optionally, the registration details of the third party provider are verified by the telecommunications provider as mentioned at step 520. In an embodiment, the verification department checks if all the registration details are authentic and legally correct. In case the verification of the third party provider is negative, then, the reseller exchange system 114 restricts/blocks the third party provider from doing business using the reseller exchange system 114 as shown at step 525.

At step 530, if the verification process of the third party provider is accurate, the reseller exchange system 114 enables the agreement option for the third party provider at step 525. In an embodiment, the reseller exchange system 114 is configured to include a provision for customizing the agreement for the one or more products/services of the third party provider. Such details include without limitation deciding the commission depending on volume, limiting the product/service depending on the customer's rank etc.

Once a third party provider 104 provides the details pertaining to the agreement to the reseller exchange system 114, the reseller exchange system 114 is configured to allow the third party provider for updating the details of the product/service(s) on the reseller exchange system 114 at step 535. In an embodiment, the details of the product/service fields may be entered manually. Alternately, server details of the third party provider are shared with the reseller exchange system 114. Subsequently, the reseller exchange system 114 accesses information about the products/services of the third party provider and maintains an inventory of the products/services.

By way of example, each product/service when updated on the reseller exchange system 114 is assigned with a unique identifier. The product/service detail as well as units (pieces)/license corresponding to the unique ID are updated in the inventory of the reseller exchange system 114. In an embodiment, the reseller exchange system 114 updates the inventory when one or more product/service information is updated/deleted by the third party provider. Additionally, the reseller exchange system 114 updates the inventory when one or more products/services information is updated/deleted on the server of the third party provider.

In case the user selects an option for registering as a customer, the reseller exchange system 114 provides the user with the customer registration form at step 540.

At step 545, the reseller exchange system 114 is configured to enable the agreement option for the customer at step 550. In an embodiment, the reseller exchange system 114 is configured to acquire agreement details between the one or more customers and the telecommunications provider. Additionally, once the customer provides details corresponding to the agreement, the reseller exchange system 114 is configured to provide the customer with the products/services catalogue having diverse and complex array of products and services, often with different pricing and service level guarantees to different customers and one more search fields to submit/filter products/services therethrough. The process stops at step 525.

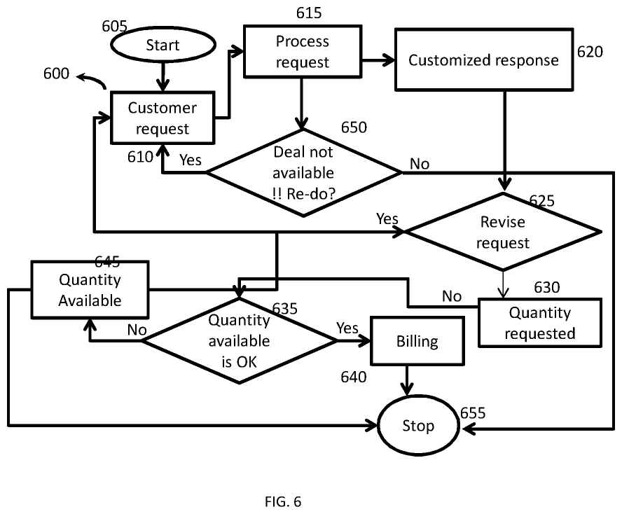

FIG. 6 illustrates a flowchart 600 depicting an exemplary process of functioning of the reseller exchange system 114 consistent with the teachings of the present invention.

The process commences at step 605, the reseller exchange system 114 is configured to simultaneously handle one or more requests from one or more registered customers. As a way of example, the reseller exchange system 114 is configured to receive a request from a customer using the client 104 for purchasing the one or more products/services through the reseller exchange system 114 residing on the server 102 as shown at step 610. The customer provides one or more parameters to be searched in a search interface of the RES 114 at step 610. In an embodiment, the parameters include without limitation product/service name, brand, no of pieces/licenses of the product/services, price/subscription cost, license type, payment mode (instalment/lump sum) etc. The parameters are received at the RES 114 through the web browser 108 of the client 104.

The RES 114 is configured to interpret the parameters and processes the customer's request as per teachings of the present invention as shown at step 615. The RES 114 identifies the customer using the parameters received for example, by way of a customer id. Thereafter, in an embodiment, the reseller exchange system 114 refers to the agreement fields of the one or more third party providers while identifying the product/service that may be offered to the customers for purchase deals. Additionally and optionally, the RES 114 is configured to check the discounts that may be offered to the said customer as per AGG_C agreement and may also consider applicable volume commission as per the AGG_TPP agreement while calculating the special price for the said product/service. Accordingly, the RES 114 is configured to identify all possible products/services based on the customer request parameter with corresponding special pricing as per the process disclosed above. Thus, in response to the customer request, the RES 114 fetches a list of possible products/service with special pricing and/or other service deal, quantities/licenses available, type of license, warranty/guarantee that may be offered to the customer as shown at step 620.

The RES 114 is configured to provide an option to the customer to submit/revise a request in case the customer wishes to do so at step 625. In case, the customer wishes to modify the search fields to view other possible options, the reseller exchange system 114 is configured to display an option for search fields to refine possible products/services as shown at step 610 and repeat the same step as mentioned above.

In case, the customer wishes to continue with an existing set of search results containing for example, a list of possible products/service with special pricing and/or other service deal, warranty/guarantee etc., the reseller exchange system 114 is configured to ask the customer to select the product/service with desired number of units (pieces)/licenses as depicted at step 630. The customer may request for at least one unit/license of product/service through the reseller exchange system 114.

At step 635, the reseller exchange system 114 is configured to check the availability of the requested number of units/licenses corresponding to the product/service in the stock thereof. In case, the number of units/licenses corresponding to the product/service is available in the inventory of the reseller exchange system 114, the reseller exchange system 114 may be configured to add the product/service with units/licenses into a customer cart (not shown) and checkout for billing at step 640. Alternatively, the reseller exchange system 114 is configured to ask the customer whether to continue to purchase more products/services after adding the product/service with selected number of units/licenses into the customer cart. Optionally, the reseller exchange system is configured to allow the customer to directly checkout for billing after selecting the required units/licenses corresponding to the product/services.

Once the customer places a request for invoicing of the selected product/services, the reseller exchange system 114 is configured to generate an invoice reflecting an amount corresponding to the purchase made. In an embodiment, the reseller exchange system 114 communicates with the account payable system to generate an invoice reflecting an amount corresponding to the purchase made at that instant. Optionally, the reseller exchange system 114 is configured to ask the customer whether to add a charge for the product(s) and/or service(s) procured by the customer(s) to the customer's regular bill or to generate a separate invoice corresponding to the purchase made at that instant. In an embodiment, per unit/per license special price corresponding to the product/service is decided by the reseller exchange system 114 by considering without limitation the agreement(s) between the customer and the telecommunication provider as well as the agreed contracts between the third party provider and the telecommunication provider. The RES 114 takes into account the values agreed upon corresponding to the applicable fields of the agreement and calculates per unit/per license special price.

In case, the number of units/licenses corresponding to the product/service is less than requested or not available in the inventory of the reseller exchange system 114, the reseller exchange system 114 is configured to display to the user the exact number of units/licenses corresponding to the product/service available in the stock of the reseller exchange system 114 or a notification like “deals not found” at step 645. Optionally, the reseller exchange system 114 may be configured to display a message/pop up to client 104 of the customer to revise the request for the units/licenses corresponding to the product/service as per the availability number of units/licenses in the inventory of the reseller exchange system 114 as shown at step 625. Otherwise, the customer may stop search and process ends at 655.

In an embodiment, once the invoice is raised, the reseller exchange system 114 may be configured to update the accounts payable in the payment system so that the third party provider is accurately paid. Additionally, the reseller exchange system 114 updates the inventory based on the number of units/licences sold for the product/service of the one or more third party provider or the telecommunication provider.

Optionally, the reseller exchange system 114 may update the inventory based upon an event or at periodic intervals. Moreover, the reseller exchange system 114 may send an alert (email/SMS etc.) to one or more third party provider once, the units/licences for the product/service is below a certain limit say 5 or as per the third party provider's configured setting so that more stock of product/services can be updated into the inventory of the reseller exchange system 114.

The process stops at step 655.

From the above it may be seen that the reseller exchange system provides extensive range of products/services to customers of a telecommunications provider without incurring management and logistical overheads. Additionally, the reseller exchange system benefits the customer as the customer receives a single consolidated invoice for the purchase of the product and/or the services of the third party provider along with the services of the telecommunications provider.

Various embodiments to the above invention are possible and would fall within the teachings of the present invention. Such embodiments include authentication between the server of the telecommunication provider and the reseller exchange system for channelizing communication during the first login.

The foregoing description of preferred embodiments of the present disclosure provides illustration and description, but is not intended to be exhaustive or to limit the disclosure to the precise form disclosed. Modifications and variations are possible in light of the above teachings or may be acquired from practice of the disclosure.

No element, act, or instruction used in the description of the present disclosure should be construed as critical or essential to the invention unless explicitly described as such. Also, as used herein, the article “a” is intended to include one or more items. Where only one item is intended, the term “one” or similar language is used.

What is claimed is:

1. A reseller exchange system of a telecommunications provider, the reseller exchange system comprising:
a processor coupled to a memory, the processor configured to communicate over a network with disparately located one or more clients, the processor configured to execute the following computer-executable instructions stored in the memory:
a product/service catalogue configured to include one or more products/services of one or more third party providers;
a database configured to include one or more agreements between a telecommunications provider and at least one of one or more customers or the one or more third party providers; and
a configuration module configured to customize billing details of the one or more products/services to be marketed and/or sold to the one or more customers using the one or more agreements.

2. The reseller exchange of claim 1 wherein the configuration module is configured to display a select product/service to a select customer.

3. The reseller exchange of claim 1 wherein the configuration module is configured to manage details of the products/services including details that are visible to the one or more customer(s) and details that are for internal reference.

4. The reseller exchange of claim 1 wherein the configuration module is configured to override standard pricing on any individual transaction.

5. The reseller exchange of claim 1 wherein the reseller exchange system is configured to allow the telecommunications provider to assemble a bundle of the one or more products/services of the one or more third party providers, and present said bundle of products/services as a single product/service to the customer.

6. The reseller exchange of claim 1 wherein the one or more products/services include disparate products/services.

7. The reseller exchange of claim 1 further comprising a billing configuration module configured to add a charge for any product or service procured by the telecommunications provider's customer(s) to a customer's regular bill.

8. The reseller exchange of claim 1 further comprising a billing configuration module to communicate with a telecommunications provider's accounts payable system to accurately pay the one or more third party providers.

9. A method for reselling one or more products/services by a telecommunications provider, comprising:
employing at least a processor configured to execute computer-executable instructions stored in a memory to perform the following acts:
storing one or more products/services of one or more third party providers;
storing one or more agreements between a telecommunications provider and at least one of one or more customers or the one or more third party providers; and
customizing billing details of the one or more products/services to be marketed and/or sold to the one or more customers of the telecommunications provider using the one or more agreements.

10. The method of claim 9 further comprising displaying a select product/service to a select customer.

11. The method of claim 9 further comprising managing details of the products/services including details that are visible to the one or more customer(s) and details that are for internal reference.

12. The method of claim 9 further comprising overriding standard pricing on any individual transaction.

13. The method of claim 9 further comprising assembling a bundle of the one or more products/services of the one or more third party providers, and present said bundle of products/services as a single product/service to the customer.

14. The method of claim 9 wherein the one or more products/services include disparate products/services.

15. The method of claim 9 further comprising adding a charge for any product or service procured by the telecommunications provider's customer(s) to a customer's regular bill.

16. The method of claim 9 further comprising communicating with a telecommunications provider's accounts payable system to accurately pay the one or more third party providers.
